(19) United States
(12) Patent Application Publication
(10) Pub. No.: US 2010/0056372 A1
(43) Pub. Date: Mar. 4, 2010

(54) COMPOSITIONS AND METHODS FOR PROVIDING MICRONUTRIENTS TO CROPS

(75) Inventor: Chapman Mayo, St. Paul, MN (US)

Correspondence Address: LEFFERT JAY & POLGLAZE, P.A., P.O. BOX 581009, MINNEAPOLIS, MN, 55458-1009, US

(73) Assignee: Agro-K Corporation

(21) Appl. No.: 12/198,215

(22) Filed: Aug. 26, 2008

(51) Int. Cl. A01N 59/16; A01N 55/02; A01N 59/06; A01P 21/00; A01N 57/20

(52) U.S. Cl. 504/120; 504/126; 504/127; 504/119

(57) ABSTRACT

Compositions containing one or more metal phosphites are suitable for providing micronutrients for plant health and can be combined with glyphosate-containing herbicides either in a mixed composition or applied separately without concern of chelation of the micronutrient metal by the glyphosate.

### TECHNICAL FIELD

The present invention relates generally to providing micronutrients to agricultural crops, and in particular, in one or more embodiments, the present disclosure relates to compositions and use of metal phosphites with and without glyphosate-based herbicides.

### BACKGROUND

Glyphosate [N-(phosphonomethyl)glycine] is a popular and effective broad spectrum herbicide. A common glyphosate herbicide is sold under the brand name ROUNDUP from the Monsanto Company, St. Louis, Mo., USA. Although glyphosate herbicides provide highly effective weed control, it is generally non-selective and can have strong non-target effects. Thus, if used as a post-emergence herbicide, conventional crops could be destroyed.

The Monsanto Company has genetically engineered several crops to be glyphosate resistant, thus allowing ROUNDUP to be used as a post-emergence herbicide. These herbicide tolerant crops (HTC) from Monsanto are marketed as ROUNDUP READY crops. For example, alfalfa, corn, soybeans and sugar beets are examples of field crops that have been genetically engineered to produce plants that are glyphosate resistant. Although these engineered crops permit the use of glyphosate as a post-emergence herbicide, there is a recognized yield loss over conventional crops. For example, with ROUNDUP READY corn, this yield drag can result in a loss of 10-30 bushels per acre. At least a part of this yield drag is the result of a reduction in availability of micronutrients following glyphosate application.

One response is to apply additional micronutrients to the soil to compensate for this reduction in availability. However, glyphosate is a strong chelating agent, and it has been shown that the addition of micronutrients with the glyphosate results not only in a reduction of efficacy of the glyphosate but little improvement in nutrient availability as the minerals tend to bind with the glyphosate. An alternative is to wait 8-10 days following glyphosate application before applying the micronutrients, thus allowing the glyphosate levels in the crop to subside. While this has been shown to reduce the yield drag resulting from glyphosate use, this process requires that the farmer make an additional trip to the field to perform this second application.

For the reasons stated above, and for other reasons which will become apparent to those skilled in the art upon reading and understanding the present specification, there is a need in the art for alternative approaches to improving micronutrient availability in agricultural crops.

### BRIEF DESCRIPTION OF THE DRAWINGS

FIG. 1 is a graph of study results for green foxtail control using a control solution containing glyphosate and test solutions in accordance with embodiments of the disclosure containing a metal phosphite with glyphosate.

FIG. 2 is a graph of study results for barnyard grass control using a control solution containing glyphosate and test solutions in accordance with embodiments of the disclosure containing a metal phosphite with glyphosate.

FIG. 3 is a graph of results of another study for barnyard grass control using a control solution containing glyphosate and test solutions in accordance with embodiments of the disclosure containing a metal phosphite with glyphosate.

FIG. 4 is a graph of study results for kochia control using a control solution containing glyphosate and test solutions in accordance with embodiments of the disclosure containing a metal phosphite with glyphosate.

FIG. 5 is a graph of study results for pigweed control using a control solution containing glyphosate and test solutions in accordance with embodiments of the disclosure containing a metal phosphite with glyphosate.

FIG. 6 is a graph of results of another study for pigweed control using a control solution containing glyphosate and test solutions in accordance with embodiments of the disclosure containing a metal phosphite with glyphosate.

FIG. 7 is a graph of study results for velvet leaf control using a control solution containing glyphosate and test solutions in accordance with embodiments of the disclosure containing a metal phosphite with glyphosate.

FIG. 8 is a graph of study results for soybean crop injury using a control solution containing glyphosate and test solutions in accordance with embodiments of the disclosure containing a metal phosphite with glyphosate.

FIG. 9 is a graph of results of another study for soybean crop injury using a control solution containing glyphosate and test solutions in accordance with embodiments of the disclosure containing a metal phosphite with glyphosate.

FIG. 10 is a graph of study results for corn crop injury using a control solution containing glyphosate and test solutions in accordance with embodiments of the disclosure containing a metal phosphite with glyphosate.

FIG. 11 is a graph of study results for alfalfa crop injury using a control solution containing glyphosate and test solutions in accordance with embodiments of the disclosure containing a metal phosphite with glyphosate.

### DETAILED DESCRIPTION

In the following detailed description of the present embodiments, reference is made to the accompanying drawings that form a part hereof, and in which is shown by way of illustration specific embodiments in which the disclosure may be practiced. These embodiments are described in sufficient detail to enable those skilled in the art to practice the invention, and it is to be understood that other embodiments may be utilized and that process, chemical, or mechanical changes may be made without departing from the scope of the present disclosure. The following detailed description is, therefore, not to be taken in a limiting sense.

To address the reduced micronutrient availability inherent from the use of glyphosate as a post-emergence herbicide, various embodiments employ metal phosphites that can be mixed with glyphosate-containing herbicides or applied separately without concern of the chelating problems seen with metal sulfates, a common source of micronutrients used for field crops. Certain metal phosphites, e.g., zinc phosphite (ZnHPO₃), manganese phosphite (MnHPO₃), magnesium phosphite (MgHPO₃), calcium phosphite (CaHPO₃) and copper phosphite (CuHPO₃), have been used with fruit crops, and are known to be systemic micronutrients.

Testing of various embodiments described herein of aqueous solutions containing metal phosphites and glyphosate has shown no substantial reduction in glyphosate efficacy over glyphosate alone for several common weeds. Such testing has further shown no significant increase or decrease in crop injury levels for several ROUNDUP READY crops.

In particular, a greenhouse study has been performed to evaluate solutions containing manganese phosphite and glyphosate, and solutions containing zinc phosphite and glyphosate. These solutions were compared to a control of ROUNDUP applied as a single application at the rate of approximately 0.75 lbs glyphosate per acre. When used herein, unless stated otherwise, rates of glyphosate application and concentration of glyphosate refers to the acid equivalent (ae) rate or concentration. This is used because glyphosate herbicides are typically formulated as salts of the parent acid. As the salt generally does not contribute to the efficacy of the compound as an herbicide, the acid equivalent value is generally accepted as more meaningful. Example salts of glyphosate include isopropylamine, potassium, trimethylsulfonium, and diammonium.

The tested crops included ROUNDUP READY soybeans, corn, alfalfa and sugar beets. The tested weeds included green foxtail, barnyard grass, kochia, pigweed and velvet leaf. The study was repeated twice on all of the crops and most of the weeds.

The test solutions included single applications of the ROUNDUP control solution mixed with solutions of MnHPO₃ containing approximately 3.5% of manganese and solutions of ZnHPO₃ containing approximately 6.5% of zinc. When referring to concentrations herein, percentages refer to weight percentages. Furthermore, weights and concentrations of the metal phosphites are determined on a metal basis, i.e., the phosphite anion (HPO₃) is not considered in calculating weight or concentration, as the corresponding metals are the desired micronutrients. Such metal phosphites may be produced, for example, through the reaction of a metal carbonate with phosphorous acid. For example, a reaction product of manganese carbonate and phosphorous acid is manganese phosphite. The solutions are summarized in Table 1.

TABLE 1

| | Glyphosate | Mn as MnHPO₃ | Zn as ZnHPO₃ |
|---|---|---|---|
| | (lbs/acre | (lbs/acre | (lbs/acre |
| Solution | [kg/hectare]) | [kg/hectare]) | [kg/hectare]) |
| Control | 0.75 [0.84] | 0 [0] | 0 [0] |
| 1 | 0.75 [0.84] | 0.0875 [0.0981] | 0 [0] |
| 2 | 0.75 [0.84] | 0.1750 [0.1961] | 0 [0] |
| 3 | 0.75 [0.84] | 0 [0] | 0.1625 [0.1821] |
| 4 | 0.75 [0.84] | 0 [0] | 0.3250 [0.3643] |

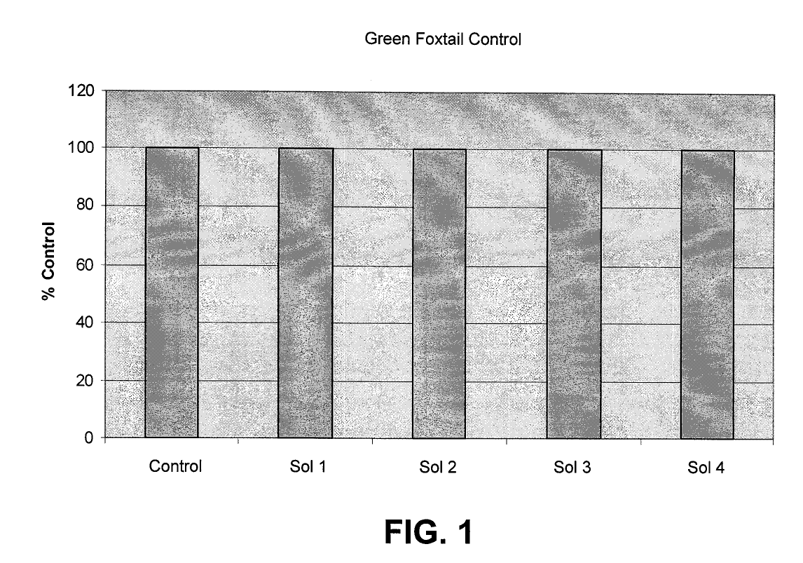

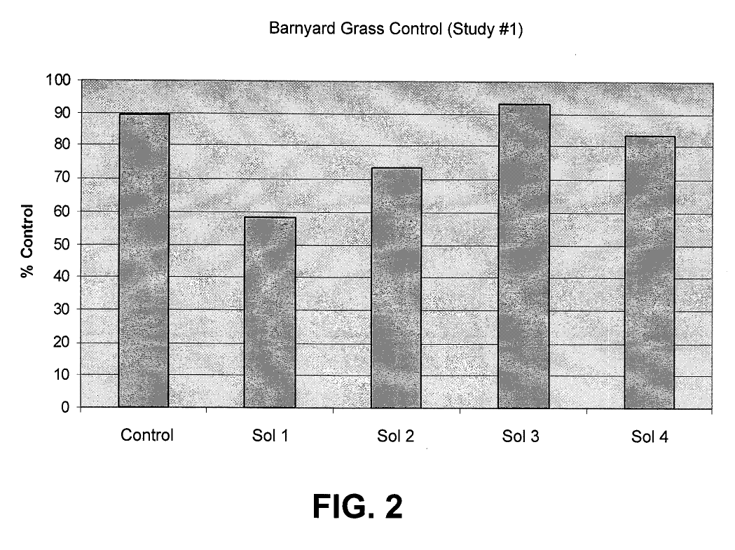

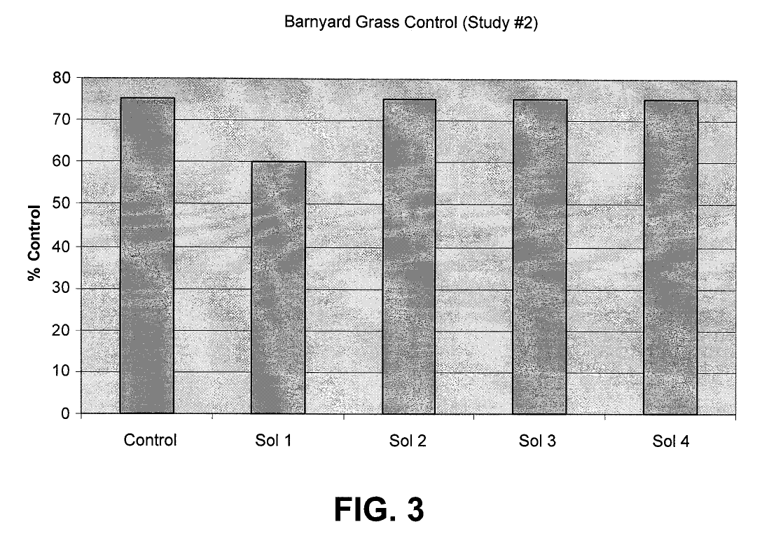

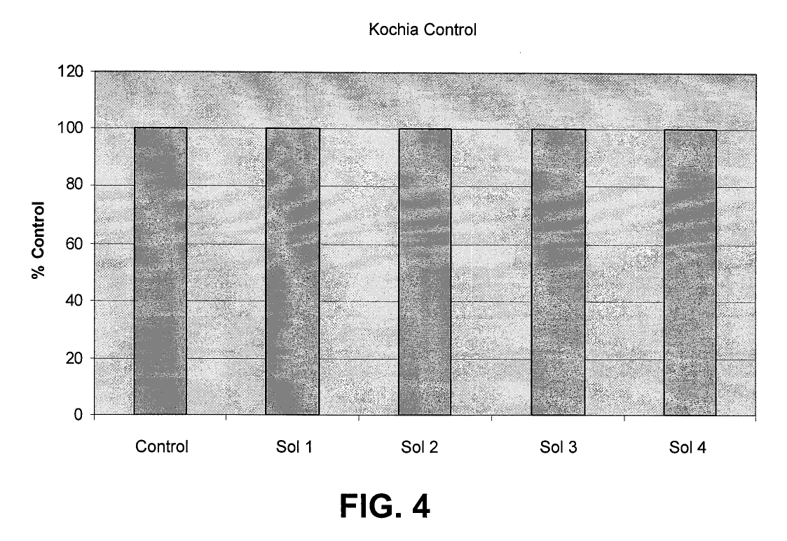

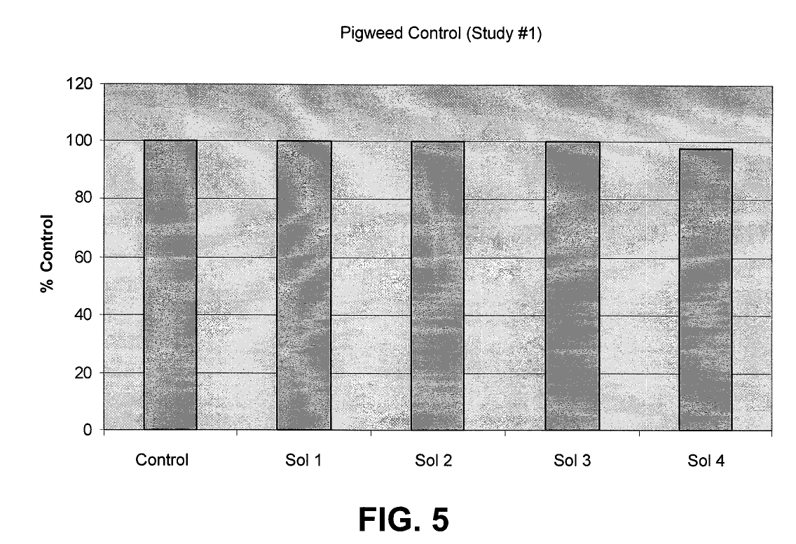

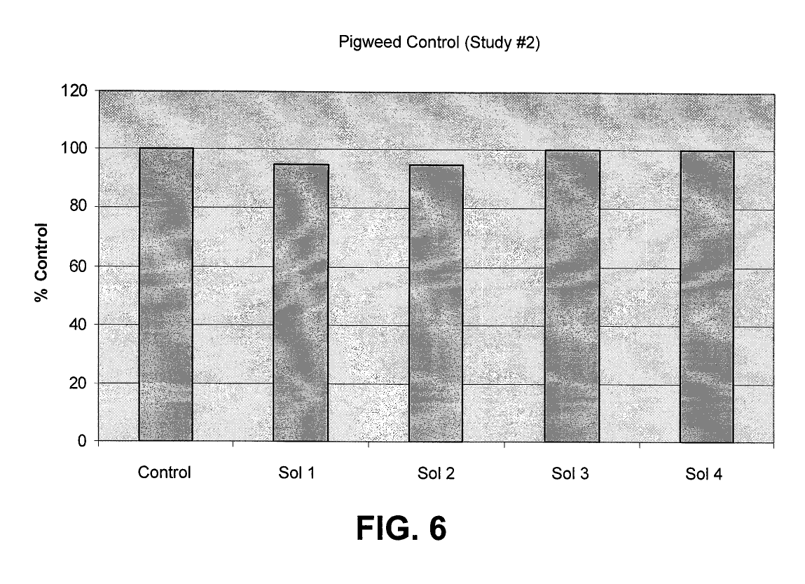

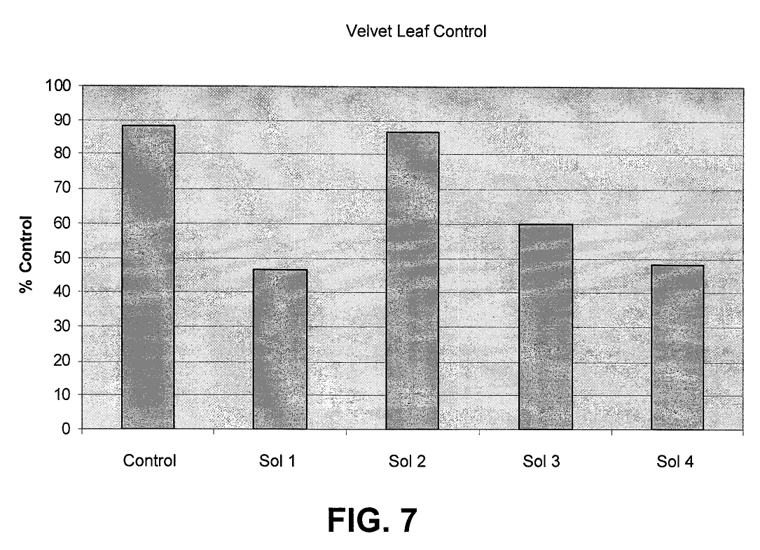

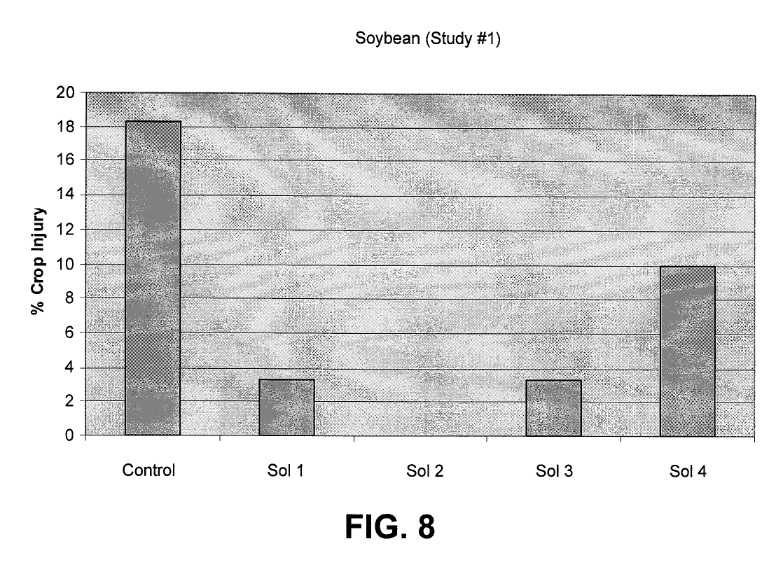

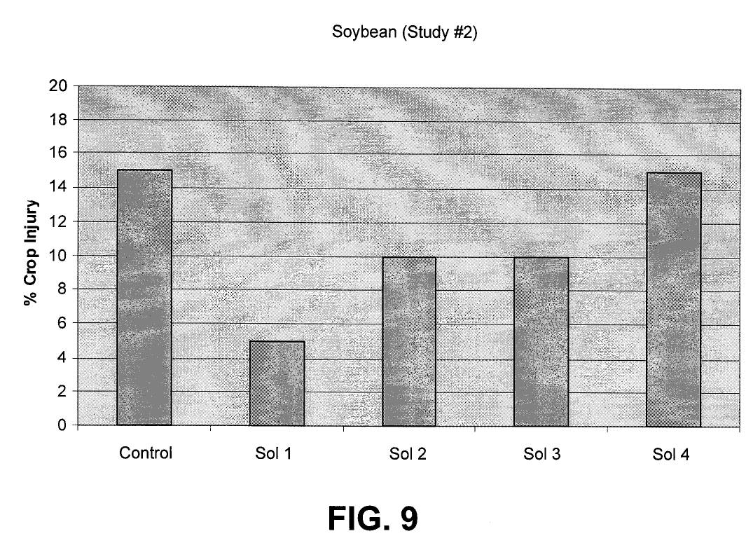

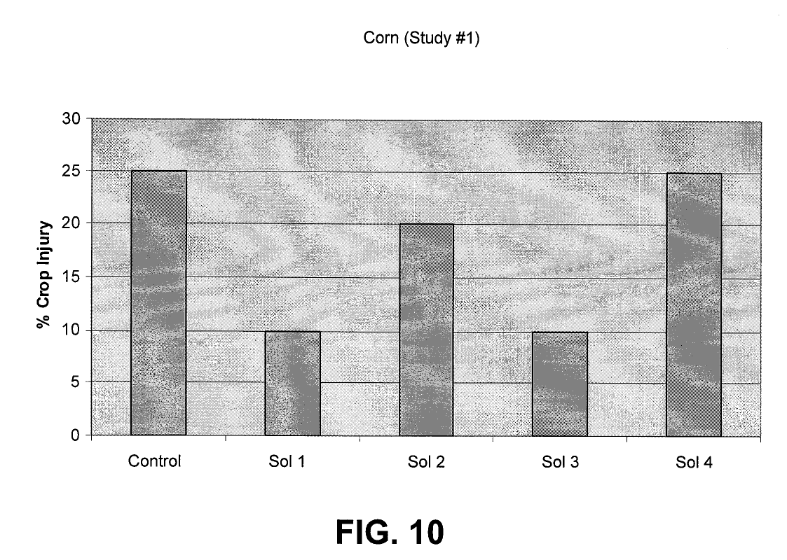

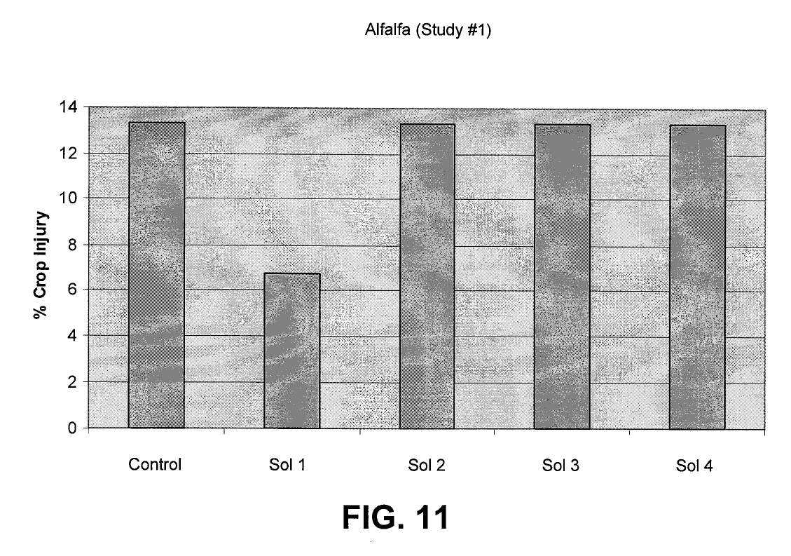

FIGS. 1-7 depict study results for the efficacy of the control and test solutions in controlling a variety of common weeds. As demonstrated in FIGS. 1-7, there was no major evidence of antagonism or synergy observed with weed control when mixing the tested metal phosphites with the glyphosate. FIGS. 8-11 depict study results for observed crop injury from the use of the control and test solutions with a variety of common field crops. Additional studies, including one for corn, one for alfalfa and two for sugar beets, are not depicted herein as there was no observed crop injury for both the control solution and the test solutions. As demonstrated in FIGS. 8-11, and as demonstrated in the additional studies in which no crop injury was observed, there was no significant evidence of increased or decreased crop injury when mixing the tested metal phosphites with the glyphosate.

Because there was no significant evidence of a reduction in efficacy of the glyphosate for common weed control, it can be inferred that the metals of the metal phosphites are not being bound up with the glyphosate, and are thus available for plant uptake. Furthermore, these studies indicate that these metal phosphites can be tank-mixed with the glyphosate herbicide, thus allowing a farmer to make a single pass to apply the glyphosate herbicide and the metal phosphite micronutrients concurrently. It is thus expected that a variety of micronutrients in the form of metal phosphites could be co-applied with glyphosate-containing herbicides. Example micronutrients in accordance with various embodiments include zinc (Zn), manganese (Mn), magnesium (Mg), calcium (Ca), iron (Fe) and copper (Cu). Thus, metal phosphites for use in accordance with various embodiments include zinc phosphite (ZnHPO₃), manganese phosphite (MnHPO₃), magnesium phosphite (MgHPO₃), calcium phosphite (CaHPO₃), iron phosphite (FeHPO₃) and copper phosphite (CuHPO₃).

In accordance with various embodiments, compositions for providing micronutrients and herbicidal activity include aqueous solutions containing one or more metal phosphites and glyphosate. The glyphosate form may be an acid salt. The compositions should contain an efficacious amount of glyphosate to provide for the desired weed control and an efficacious amount of micronutrients for promoting plant health. For example, compositions in accordance with various embodiments of this disclosure include aqueous solutions containing 1-10% of one or more metal phosphites, measured on a metal basis, and 15-45% of glyphosate. As further examples, compositions in accordance with various embodiments of this disclosure include aqueous solutions containing 1-10% of manganese as MnHPO₃ and/or 1-10% of zinc as ZnHPO₃, and 15-45% of glyphosate. While such concentrations are believed to be appropriate for ease of manufacturing and economy in transportation, these compositions may be combined with additional water prior to application. Alternatively, compositions in accordance with various embodiments of this disclosure include aqueous solutions containing 0.02-1.0 lbs (0.01-0.45 kg) of one or more metal phosphites, measured on a metal basis, for every 1 lb (0.45 kg) of glyphosate. In this manner, application rates of glyphosate can be approximately 0.5-1.5 lbs/acre (0.6-1.7 kg/hectare) while providing 0.01-1.5 lbs/acre (0.01-1.7 kg/hectare) of each of the micronutrients, without regard to concentration of the applied solution. For example, one range of compositions may include 0.08-0.25 lbs (0.04-0.11 kg) of manganese as MnHPO₃ and 0.08-0.25 lbs (0.04-0.11 kg) of zinc as ZnHPO₃ per 1 lb (0.45 kg) of glyphosate. At a glyphosate application rate of 0.75 lbs/acre (0.84 kg/hectare), such a range of compositions would provide 0.06-0.19 lbs/acre (0.07-0.21 kg/hectare) of manganese and 0.06-0.19 lbs/acre (0.07-0.21 kg/hectare) of zinc.

While Applicant believes there is a substantial benefit to tank-mixing the micronutrients with the herbicide, it is also inferred that these micronutrients could be applied before or after the application of glyphosate without the need to employ the conventional waiting period for uptake of micronutrients by the plant before glyphosate application or for dissipation of glyphosate levels in the plant after glyphosate application. Thus, in accordance with additional embodiments, compositions for providing micronutrients include aqueous solutions containing two or more metal phosphites. For example, compositions in accordance with various embodiments of this disclosure include aqueous solutions containing 1-10% of each of the two or more metal phosphites, measured on a metal basis. It is expected that upon increasing the total metal content in a mix of two or more metal phosphites, one or more of the phosphites would begin to drop from solution at some saturation point. However, it can be easily determined without undue experimentation what concentration of some desired mix of micronutrient phosphites could be sustained in solution. For certain embodiments, embodiments utilizing combinations of two or more metal phosphites include at least one of manganese phosphite and zinc phosphite.

As further examples, compositions in accordance with embodiments of this disclosure include aqueous solutions containing 1-10% manganese as MnHPO₃ and 1-10% of zinc as ZnHPO₃. For a further embodiment, a composition for providing micronutrients includes an aqueous solution containing approximately 4% manganese as MnHPO₃ and 4% of zinc as ZnHPO₃. It is recognized that industrial processing is generally not exact and, as such, concentrations may easily have a variability of ±1%. Such solutions can be applied to the soil or crops prior to glyphosate application, mixed with glyphosate for co-application or applied after glyphosate application. As one example, the foregoing 4% Mn/4% Zn solution is tank-mixed with an aqueous solution containing glyphosate in sufficient quantities to provide an application rate of approximately one to two quarts of the Mn/Zn solution per acre. Alternatively, the foregoing 4% Mn/4% Zn solution is applied at an application rate of approximately one to two quarts of the Mn/Zn solution per acre prior to, or following, glyphosate application. Such applications can occur within seven days of glyphosate application with no significant loss of nutrient availability expected due to chelation by the glyphosate.

Compositions in accordance with various embodiments may further contain additional chemical components that do not materially affect the basic and novel properties of the compositions disclosed herein. Some examples include dyes, stabilizers, buffers, surfactants, preservatives, fungicides, other herbicides, and non-metal nutrients. Compositions containing glyphosate should be foliar applied for weed control efficacy. Weed control spraying is generally delayed until emergence of at least the weeds, and may be repeated one or more times after emergence of the target crop.

Although specific embodiments have been illustrated and described herein, it will be appreciated by those of ordinary skill in the art that any arrangement that is calculated to achieve the same purpose may be substituted for the specific embodiments shown. Many adaptations of the disclosure will be apparent to those of ordinary skill in the art. Accordingly, this application is intended to cover any adaptations or variations of the disclosure.

What is claimed is:

1. A method of treating agricultural crops, comprising:
applying a composition to a crop, wherein the composition comprises glyphosate and one or more metal phosphites in aqueous solution;
wherein the one or more metal phosphites are selected from the group consisting of zinc phosphite, manganese phosphite, magnesium phosphite, calcium phosphite, iron phosphite and copper phosphite.

2. The method of claim 1, wherein applying the composition comprises applying the composition comprising an acid salt form of the glyphosate.

3. The method of claim 1, wherein applying the composition comprises applying the composition at a rate to provide an amount of glyphosate that is efficacious for weed control.

4. The method of claim 1, wherein applying the composition comprises applying an aqueous solution comprising 0.02-1.0 lbs of one or more of the metal phosphites, measured on a metal basis, for every 1 lb of glyphosate.

5. The method of claim 1, wherein applying the composition comprises applying an aqueous solution comprising 0.08-0.25 lbs of manganese as manganese phosphite and 0.08-0.25 lbs of zinc as zinc phosphite for every 1 lb of glyphosate.

6. The method of claim 1, wherein applying the composition comprises applying the composition to provide 0.5-1.5 lbs/acre of glyphosate and 0.01-1.5 lbs/acre of one or more of the metal phosphites, measured on a metal basis.

7. A composition for treatment of agricultural crops, comprising:
glyphosate;
one or more metal phosphites; and
water;
wherein the one or more metal phosphites are selected from the group consisting of zinc phosphite, manganese phosphite, magnesium phosphite, calcium phosphite, iron phosphite and copper phosphite.

8. The composition of claim 7, wherein the glyphosate is in an acid salt form.

9. The composition of claim 8, wherein the acid salt form is selected from the group consisting of isopropylamine, potassium, trimethylsulfonium and diammonium salts of the glyphosate.

10. The composition of claim 7, wherein the composition is an aqueous solution comprising 1-10% by weight of one or more of the metal phosphites, measured on a metal basis, and 15-45% by weight of glyphosate.

11. The composition of claim 10, wherein at least one of the metal phosphites is selected from the group consisting of zinc phosphite and manganese phosphite.

12. The composition of claim 7, wherein the composition comprises 0.02-1.0 lbs of one or more of the metal phosphites, measured on a metal basis, for every 1 lb of glyphosate.

13. The composition of claim 12, wherein the composition comprises 0.08-0.25 lbs of manganese as manganese phosphite and 0.08-0.25 lbs of zinc as zinc phosphite for every 1 lb of glyphosate.

14. A composition for treatment of agricultural crops, comprising:
two or more metal phosphites; and
water;
wherein the two or more metal phosphites are selected from the group consisting of zinc phosphite, manganese phosphite, magnesium phosphite, calcium phosphite, iron phosphite and copper phosphite; and
wherein at least one of the metal phosphites is selected from the group consisting of zinc phosphite and manganese phosphite.

15. The composition of claim 14, wherein the glyphosate is in an acid salt form.

16. The composition of claim 14, wherein the composition is an aqueous solution comprising 1-10% by weight of one or more of the metal phosphites, measured on a metal basis.

17. The composition of claim 14, wherein the composition is an aqueous solution comprising 1-10% by weight of zinc as zinc phosphite and 1-10% by weight of manganese as manganese phosphite.

18. A method of treating agricultural crops, comprising:
applying a composition to a crop, wherein the composition comprises one or more metal phosphites in aqueous solution; and
applying glyphosate to the crop within seven days of applying the composition;
wherein the one or more metal phosphites are selected from the group consisting of zinc phosphite, manganese phosphite, magnesium phosphite, calcium phosphite, iron phosphite and copper phosphite.

19. The method of claim 18, wherein applying glyphosate comprises applying an acid salt form of the glyphosate.

20. The method of claim 18, wherein applying glyphosate comprises applying the glyphosate prior to applying the composition.

21. The method of claim 18, wherein applying the composition comprises applying an aqueous solution at a rate to provide 0.02-1.0 lbs of one or more of the metal phosphites, measured on a metal basis, for every 1 lb of glyphosate applied.

22. The method of claim 18, wherein applying the composition comprises applying an aqueous solution at a rate to provide 0.08-0.25 lbs of manganese as manganese phosphite and 0.08-0.25 lbs of zinc as zinc phosphite for every 1 lb of glyphosate applied.

23. The method of claim 18, wherein applying the composition comprises applying an aqueous solution at a rate to provide 0.01-1.5 lbs/acre of one or more of the metal phosphites, measured on a metal basis.

24. The method of claim 23, wherein applying glyphosate to the crop comprises applying the glyphosate at a rate to provide 0.5-1.5 lbs/acre.
